(19) United States
(12) Patent Application Publication
(10) Pub. No.: US 2023/0344962 A1
(43) Pub. Date: Oct. 26, 2023

(54) VIDEO FRAME INTERPOLATION USING THREE-DIMENSIONAL SPACE-TIME CONVOLUTION

(71) Applicant: Meta Platforms, Inc., Menlo Park, CA (US)

(72) Inventors: Du Le Hong Tran, Palo Alto, CA (US); Subrahmanya Sai Tarun Kalluri, San Diego, CA (US); Deepak Pathak, Union City, CA (US)

(21) Appl. No.: 17/218,827

(22) Filed: Mar. 31, 2021

(51) Int. Cl. H04N 7/01; G06N 3/08; G06N 5/04

(52) U.S. Cl. CPC H04N 7/0135; G06N 3/08; G06N 5/04; H04N 7/0127

(57) ABSTRACT

A method includes receiving an input video stream and providing, to a convolutional neural network (CNN), multiple image frames of the video stream including a target pair of consecutive frames, a frame immediately preceding the target pair, and a frame immediately following the target pair. The method includes generating, by the CNN, multiple interpolated image frames by performing 3D space-time convolution on the multiple image frames and outputting a video stream in which the interpolated image frames are inserted between the frames of the target pair. The convolution may include passing a 3D filter over the multiple image frames in common width and height dimensions, and in a depth dimension representing the number of frames. Generating the interpolated image frames may include generating image data for multiple color channels in respective convolutional layers. The CNN may be trained to predict non-linear movements that occur over multiple image frames.

### TECHNICAL FIELD

This disclosure generally relates to image processing and, more particularly, to video frame interpolation.

### BACKGROUND

Video frame interpolation is commonly used to increase the frame rate for low-frame-rate video, thus improving video quality by interpolating non-existent frames between existing frames. For example, some video sources, such as a GPU or gaming engine, generate and/or transmit low-frame-rate video for display on a portable device due to constraints on camera and/or capture limitations, or constraints on computing resources or transmission bandwidth. The device on which the video is to be displayed may perform video frame interpolation to generate and insert additional video frames to increase the quality of the video prior to display. Many existing approaches for video frame interpolation include computing bidirectional optical flow between adjacent frames of a video followed by applying a suitable warping algorithm to generate the output frames. Approaches relying on optical flow often fail to model occlusions and complex non-linear motions directly from the video and can introduce additional bottlenecks unsuitable for real time deployment.

Neural networks are increasingly being used to implement machine learning (ML) techniques to solve a wide variety of problems including, but not limited to, object identification, feature classification, or content-driven image processing. Some neural networks, which may be referred to as convolutional neural networks, include one or more convolutional layers. In a convolutional neural network (CNN), the convolutional layers typically account for the vast majority of the computations performed and the data movement within the CNN and/or between the CNN and other elements of an ML model

### SUMMARY OF PARTICULAR EMBODIMENTS

Particular embodiments described herein relate to a flexible and efficient architecture that makes use of 3D space-time convolutions to enable end-to-end learning and inference for the task of video frame interpolation. The disclosed methods efficiently learn to reason about non-linear motions, complex occlusions, and temporal abstractions resulting in improved performance over existing video interpolation approaches, while requiring no additional inputs in the form of optical flow or depth maps. In various embodiments, the disclosed method may significantly improve the inference speed compared to the current most accurate method and the current fastest method for 8× interpolation. The disclosed approach has been evaluated on a wide range of challenging settings and consistently demonstrates favorable qualitative and quantitative results compared with current methods on various popular benchmarks. The disclosed approach to video frame interpolation may also serve as a useful self-supervised pretext task for further video analytics tasks, such as action recognition, optical flow estimation, and motion magnification.

In particular embodiments, the disclosed method includes receiving an input video stream and providing, to a convolutional neural network (CNN) trained to perform video frame interpolation, multiple image frames of the video stream, sometimes referred to herein as a stack of image frames, as input. The stack of image frames includes a target pair of consecutive frames between which interpolated frames are to be inserted, at least one frame immediately preceding the target pair, and at least one frame immediately following the target pair. The method includes generating, by the CNN in a single inference pass, multiple interpolated image frames, by performing 3D space-time convolution on the stack of image frames and outputting a video stream in which the interpolated image frames are inserted between the frames of the target pair. The 3D space-time convolution may include passing a 3D filter over the multiple image frames in a width dimension common to each of the image frames in the stack of image frames, a height dimension common to each of the image frames in the stack of image frames, and a depth dimension representing the number of image frames in the stack of image frames. Generating the interpolated image frames may include generating image data for multiple color channels, e.g., RGB color channels, in respective convolutional layers. The CNN may be trained to predict non-linear movements that occur over multiple image frames, e.g., generating interpolated frames between existing frames that include intermediate frame-to-frame motion.

The embodiments disclosed herein are only examples, and the scope of this disclosure is not limited to them. Particular embodiments may include all, some, or none of the components, elements, features, functions, operations, or steps of the embodiments disclosed herein. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1 illustrates selected elements of an example of a multilayer perception (MLP) neural network.

FIG. 2 illustrates selected elements of a simplified building block of a Deep Neural Network (DNN).

FIG. 3A illustrates an example convolutional neural network (CNN) for a classification-type network.

FIG. 3B illustrates an example CNN for a UNet-type network.

FIGS. 4A and 4B illustrate the operation of example convolutional layers in respective CNNs.

FIG. 5 illustrates an example video interpolation using a video frame interpolation network.

FIG. 6 illustrates selected elements of an example method for video frame interpolation.

FIG. 7 illustrates selected elements of an example video frame interpolation network including a CNN.

FIGS. 8A through 8C illustrate respective elements of the example video frame interpolation network shown in FIG. 7.

FIG. 9A illustrates an example image frame stack input to a video frame interpolation network.

FIG. 9B illustrates example interpolated image frames output by the video frame interpolation network based on the input image frame stack shown in FIG. 9A.

FIG. 10 illustrates the use of video frame sampling for training a video frame interpolation network.

FIG. 11 illustrates selected elements of an example method for training a video frame interpolation network.

FIG. 12 illustrates selected elements of an example method for video interpolation using a trained video frame interpolation network.

FIG. 13 illustrates an example computer system.

### DESCRIPTION OF EXAMPLE EMBODIMENTS

In particular embodiments, a method for increasing the frame rate of low-frame-rate video to improve video quality by interpolating non-existent frames between existing frames may be implemented using a convolutional neural network (CNN) that has been trained to predict the motion between frames for more realistic results. Unlike existing video frame interpolation methods, which typically generate a single intermediate frame at a time using a linear interpolation between two consecutive video frames, the method may generate any arbitrary number of intermediate frames between a pair of existing frames of an input video stream in a single inference pass. In one example, to increase the frame rate by a factor of 4×, three additional video frames may be generated and displayed between each pair of video frames in the original video stream. In another example, to increase the frame rate by a factor of 8×, seven additional video frames may be generated and displayed between each pair of video frames in the original video stream.

The methods described herein perform interpolations that do not rely solely on the target pair of video frames between which additional frames are to be inserted. Instead, they include as input one or more additional video frames before and after the target pair of video frames for context. For example, each interpolation operation may take a stack of four or six consecutive video frames as input and may generate any number of additional frames to be inserted between the center two frames of the stack. Including these additional video frames allows the CNN to detect complex, non-linear movements occurring over several frames and to predict movements that would have taken place between the target pair of video frames in a higher-frame-rate video.

The CNN performing the interpolation may include any number of convolutional layers for encoding and decoding the video data, at least some of which perform three-dimensional (3D) convolution operations for each channel of the input video frames in the spatial and temporal dimensions. For example, each image frame may be of size W (width)×H (height) and may have multiple channels, and at least some layers of the CNN may apply a 3D convolution on the input stack of four or six consecutive video frames. Each 3D convolution may be performed by applying and moving 3D filters (e.g., one for each of the channels in the image data) across and down each frame in the two spatial dimensions of the input feature set and then across the four or six frames of the stack in the temporal dimension, or “depth”, of the input feature set.

The CNN may also include 2D filters for detecting and/or extracting various image features, such as colors, textures, or shapes, and gating (or attention) modules, for determining which filters are most useful to apply in a given interpolation operation. The CNN may also include skip connections between some encoders and decoders. A final 2D prediction layer may take a 3D output from the last 3D convolution layer and generate the desired number of 2D video frames to be inserted between a target pair of frames, all of which are output by the CNN at once. The CNN may be trained by providing, as input, target pairs of non-consecutive video frames of a high-frame-rate video stream as well as one or more immediately adjacent frames for context, predicting the intermediate frames between each target pair of frames, and comparing the predicted intermediate frames to the actual frames that exist between the target pairs of frames in the original high-frame-rate video stream.

Before discussing the present embodiments in further detail, it may be beneficial to provide some background information regarding neural networks and machine learning (ML) models in general. A neural network, or neural net, is a nodal network of interconnected neurons, where each neuron represents a node in the network. Groups of neurons may be arranged in layers, with the outputs of one layer feeding forward to a next layer in a multilayer perception (MLP) arrangement. MLP may be understood to be a feedforward neural network model that maps a set of input data onto a set of output data.

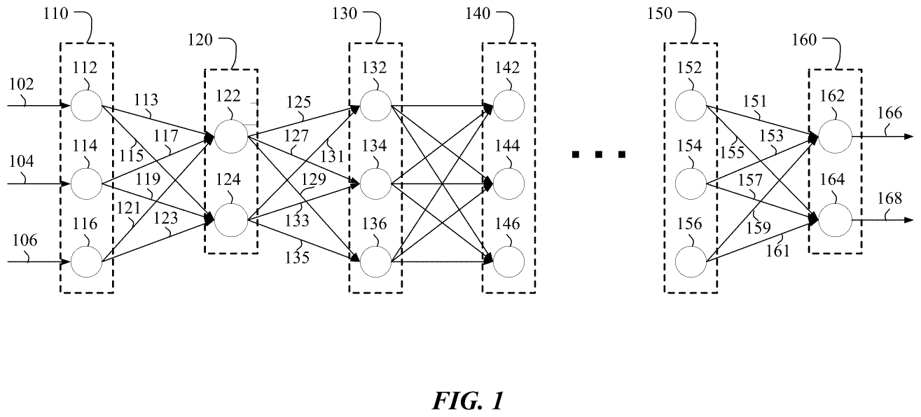

FIG. 1 illustrates selected elements of an example of a multilayer perception neural network, in accordance with particular embodiments. Its structure may include multiple hidden, e.g., internal, layers that map an input layer 110 that receives a set of inputs or a vector input to an output layer 160 that includes a set of outputs or a vector output. Each layer may include any given number of nodes, which are herein illustratively shown as circles within each layer. For example, input layer 110 includes three nodes, shown as nodes 112 114, and 116, and output layer 160 includes two nodes, shown as 162 and 164. The example neural network illustrated in FIG. 1 includes at least four hidden layers but may include additional hidden layers not shown in FIG. 1. In the illustrated example, the first hidden layer 120 includes two nodes, shown as nodes 122 and 124, while hidden layers 130, 140, and 150 each include three nodes, shown as nodes 132, 134, and 136, nodes 142, 144, and 146, and nodes 152, 154, and 156, respectively. Generally, the deeper the MLP (e.g., the greater the number of hidden layers in the MLP), the greater its capacity to learn. The input layer 110 receives a vector input, illustratively shown as a three-dimensional vector consisting of inputs 102, 104 and 106, and may apply the received vector input to the first hidden layer 120 in the sequence of hidden layers. The output layer 160 receives the output from the last hidden layer in the multilayer model, e.g., 150, processes its inputs, and produces a vector output result, illustratively shown as a two-dimensional vector consisting of outputs 166 and 168.

Typically, each neuron (or node) produces a single output that is fed forward to neurons in the layer immediately following it. However, each neuron in a hidden layer may receive multiple inputs, either from the input layer or from the outputs of neurons in a preceding hidden layer, such as the immediately preceding hidden layer or an earlier hidden layer. In general, each node may apply a function to its inputs to produce an output for that node. Nodes in hidden layers, including layers referred to as learning layers, may apply the same function or a different function to their respective input(s) to produce their respective output(s). Some nodes, however, such as the nodes in the input layer 110 may receive only one input and may be passive, meaning that each node may simply relay the value of its single input to its output(s) thus providing a copy of the input to the output(s).

In the example neural network illustrated in FIG. 1, the outputs of nodes 112, 114, and 116 of input layer 110 feed forward as inputs to hidden layer 120, which includes nodes 122 and 124. The outputs of nodes 122 and 124, in turn, feed forward as inputs to hidden layer 130, which includes nodes 132, 134, and 136, the outputs of nodes 132, 134, and 136 feed forward as inputs to hidden layer 140, which includes nodes 142, 144, and 146, and so on. Finally, the outputs of nodes 152, 154, and 156 of the final hidden layer 150 feed forward as inputs to output layer 160, which includes nodes 162 and 164. Interconnections, or links, between neurons, shown in FIG. 1 as arrows between various nodes, may have respective weights associated with them. For example, the interconnection between node 112 of input layer 110 and node 122 of hidden layer 120 may be associated with a weight 113. In addition, the interconnection between node 112 of input layer 110 and node 124 of hidden layer 120 may be associated with a weight 115, the interconnection between node 114 of input layer 110 and node 122 of hidden layer 120 may be associated with a weight 117, the interconnection between node 114 of input layer 110 and node 124 of hidden layer 120 may be associated with a weight 119, the interconnection between node 116 of input layer 110 and node 122 of hidden layer 120 may be associated with a weight 121, and the interconnection between node 116 of input layer 110 and node 124 of hidden layer 120 may be associated with a weight 123. Similarly, the interconnections between the nodes of hidden layers 120 and 130 may be associated with weights 125, 127, 129, 131, 133, and 135, respectively, and the interconnections between the nodes of hidden layers 150 and output layer 160 may be associated with weights 151, 153, 155, 157, 159, and 161, respectively. Weights associated with the remaining interconnections between nodes in the illustrated neural network are not shown in FIG. 1 for simplicity.

Typically, except for the input layer, a node (neuron) may receive as input the outputs of nodes in its immediately preceding layer. Each node may calculate its output by, e.g., multiplying each of its inputs by each input's corresponding interconnection weight, summing the products of it inputs, adding (or multiplying by) a constant defined by another weight or bias that may be associated with that particular node, and applying a function, such a non-linear or logarithmic function, to the result. The non-linear function may be referred to as an activation function or transfer function. Multiple activation functions are known in the art, and selection of a specific activation function is not critical to the present discussion. It is noted, however, that operation of the ML model, or behavior of the neural net, is dependent upon weight values, which may be learned so that the neural network provides a desired output for a given input.

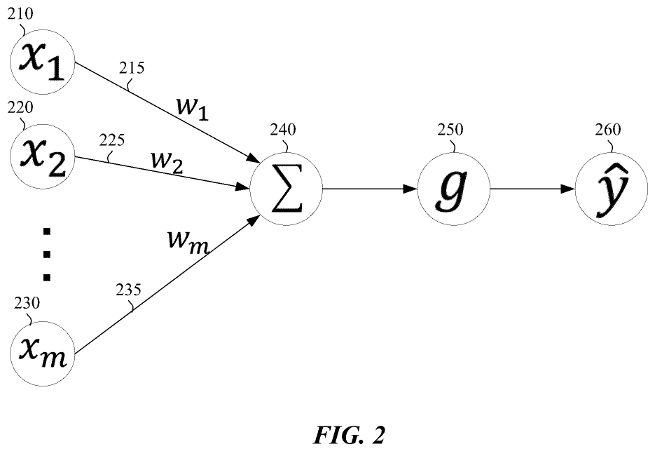

FIG. 2 illustrates, in a simplified view, selected elements of a building block of a Deep Neural Network (DNN). The illustrated building block generates an output vector for for a particular neural network node given inputs x₁ (210), x₂ (220), and x₃ (230), respective interconnection weights w₁ (215), w₂ (225), and w₃ (235), and a non-linear activation function g (250). In the illustrated example, the output vector may may be determined by applying the activation function g (250) to a linear combination of the inputs multiplied by their corresponding weights, as follows:

$$\hat{y} = g ( {\sum }_{i = 1}^{m} {x}_{i} {w}_{i} )$$

During a training, or learning, stage, the neural network may learn, e.g., may be trained to determine, appropriate weight values to achieve a desired output for a given input. Before the neural network is trained, the weights may be individually assigned an initial value, such as a random, and optionally non-zero, value. Various methods of assigning initial weights are known in the art. The weights are then trained, or optimized, so that for a given training vector input, the neural network produces an output close to a desired, e.g., a predetermined, training vector output. The desired output against which the current output is compared may be referred to as a label for the input data. A training vector input and its corresponding training vector output may be termed an input-output training pair, and a training data set may include multiple input-output training pairs, e.g., tens to millions, or more. In this manner, the weights may be incrementally adjusted in thousands of iterative cycles, such as by a technique termed back-propagation. Several back-propagation techniques are known in the art, including several based on gradient descent, such as batch gradient descent, stochastic gradient descent (SGD), which may include mini-batch gradient descent, distributed synchronous and asynchronous SGD, elastic averaging stochastic gradient descent (EASGD), Hogwild, etc. The different back-propagation techniques may differ in how specific aspects of gradient descent are implemented, but in general, irrespective of the back-propagation technique used, in each cycle of back-propagation, a training input (e.g., vector input) is fed forward through the neural network to determine its actual output (e.g., vector output). An error for each output neuron, or output node, is then calculated based on the actual neuron output and a target or desired training output for that neuron. The process then propagates back through the neural network (in a direction from the output layer back to the input layer), updating the weights based on how much effect each weight has on the overall error so that the output of the neural network moves closer to the desired training output. This cycle may then be repeated until the actual output of the neural network is within an acceptable error range of the desired training output. In machine learning, an epoch typically refers to one complete pass, including back-propagation, if applicable, of the full training dataset to be learned through the machine-learning model. In one epoch, the full training dataset may be submitted to the learning algorithm in a single training iteration, in which case a “batch” of training data is used, or the full training dataset may be submitted in the aggregate after multiple training iterations, each using a subset of the training dataset referred to as a “mini-batch”.

Construction of a neural network model, or a machine-learning model in general, may include a learning stage, which may also be referred to as a training stage, and an inference stage, which may also be referred to as an operational, execution, or service stage. In the learning stage, the neural network may be trained for a specific purpose and may be provided with a set of training examples, including training inputs and training outputs provided as input-output training pairs, and optionally including a set of validation examples to test the progress of the training. During this learning process, various weights associated with nodes and node-interconnections (e.g., links) in the neural network may be incrementally adjusted in order to reduce the error between an actual output of the neural network and the desired training output. In this manner, a multi-layer feed-forward neural network, such as that discussed above, may be made capable of approximating any measurable function to any desired degree of accuracy. The result of the learning stage is a machine learning model that has been trained. In the inference stage, an input with unknown outputs may be submitted to the trained machine learning model, e.g., to server or edge device executing the trained ML model, which may apply what has been learned to process the input to produce an output prediction.

For ease of illustration, some aspects of a neural network framework may be disclosed herein within the context of practical example implementations. Due to real-world hardware limitations, neural networks may have practical size limits. For example, some ML models may achieve large sizes of 10 GB, or more, which may require a long time to train and complicate their hardware implementation. Therefore, in particular embodiments, an ML model may be distributed among multiple similar machines, e.g., machines having identical or substantially similar architectures, using various distributive techniques. Furthermore, it is typically desirable that the hardware, e.g., a computing system, used to train an ML model be tailored to the ML model itself and that all training be done on the same computing system. At times, a computing system used to train an ML model may include fast computing devices optimized for computational capacity and remote memory banks, e.g., parameter servers, that may hold interim parameter values, e.g., weight values.

As used herein, the terms “feature” or “features” may refer to input data or output data associated with a convolution operation. In particular embodiments, the output of each layer of a convolutional neural network may be represented by features that no longer resemble the original input in content, size, and/or shape. For example, an input image including 10×10 pixels with RGB channels may be represented by 10×10×3 features. After one round of convolution, the output may be represented by 4×4×2 features that might or might not look like an image. After a second round of convolution in which the 4×4×2 features are processed, the output may be represented by a 1×1 feature that looks nothing like an image, in this example. Features organized in a 3D manner may sometimes be referred to as a “tensor” having dimensions of height (x), width (y), and a number of channels (z).

Computing systems and system configurations may be tailored not only for particular types of machine learning models and training algorithms, but also for the types of data the machine learning model is designed to process. For example, machine learning models may receive different types of inputs or features, such as dense inputs, which are typically long vectors, sparse inputs, or a combination of both. Dense feature vectors may be used to represent dense inputs and sparse feature vectors may be used to represent sparse inputs. A dense feature vector may be represented by a mostly-populated vector, e.g., a vector having mostly non-zero entries/cells. A common example of a dense feature vector is image data. As another example, a dense feature vector may include determinable descriptors common to or determinable for most users or circumstances, depending upon the specific application, which may be gleaned from multiple sources. For examples, dense features may include personal information associated with a user, information identifying a source of the input information, or other contextual information, such as a location, a time-of-day, etc. It is noted that some dense features may be obtained by user-provided input, while others may be collected from user-related demographic or geographic information, user-device status information, user network activity, or other observable user-related sources. A dense input may be thought of as a collection of multiple, definitely determinable descriptors, where each descriptor may be given a numeric value. Because dense inputs may comprise many descriptor types, e.g., many signal/value sources, that together may characterize, describe, or represent a user or circumstance, a dense input may be a large, dense vector with one or more cells/dimensions/entries in the dense vector being designated to each descriptor type.

A sparse input may reflect more semantic information related to a particular task objective. The sparse input may be defined by a sparse feature vector that identifies selections within a larger list(s) of options, such as lists that may further be divided/grouped into different categories. This may be the case when the list of identifiers that comprises the sparse input identifies individual selections from a larger list of options, such as those provided by the dense vector. As a result, a sparse vector may be characterized by having mostly zero entries, and a few non-zero entries. Consequently, a sparse vector may be represented as a series of indexes pointing to select cell positions in the larger list having non-zero values, along with each index's corresponding non-zero value for that position, with the understanding that all other positions not identified by index have a default zero value. Sparse inputs may not necessarily be directly descriptive of a user or circumstance but may instead provide auxiliary information indirectly related to the user or circumstance. Typically, because of their many zero-entry cells, sparse vectors may not be well-suited for direct input to a neural network.

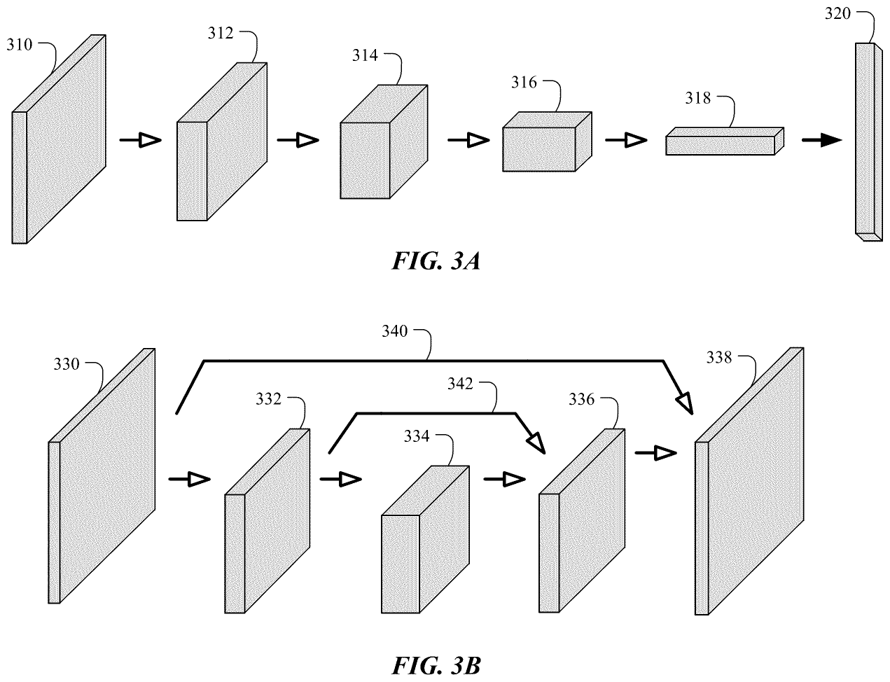

FIG. 3A illustrates an example convolutional neural network in which an output feature map 320 is generated based on an input feature map 310 in a classification-type neural network. This type of neural network may typically involve a small or medium resolution input, a single vector output, and a relatively large number of output channels. In the illustrated example, intermediate feature maps of different sizes and shapes, shown as feature maps 312, 314, 316 and 318, are generated by performing successive convolution operations on each such intermediate feature map, in turn, and the output feature map 320 is generated by a fully connected (FC) layer operating on the final intermediate feature map 318. As shown in FIG. 3A, it may be typical for the overall size, and corresponding memory requirements, to be reduced for each successive intermediate feature map in a classification-type neural network.

FIG. 3B illustrates an example CNN in which an output feature map 338 is generated based on an input feature map 330 in a UNet-type neural network. This type of neural network may involve high resolution input and/or output feature maps and a relatively small number of input and/or output channels. This type of neural network may also involve long skip connections such that a particular intermediate feature map may be dependent not only on the immediately preceding intermediate feature map but also on another previous intermediate feature map. Such skip connections are shown by arrows 340 and 342 in FIG. 3B. In the illustrated example, intermediate feature maps of different sizes and shapes, shown as feature maps 332, 334, and 336, are generated using a series of convolution operations prior to the generation of the output feature map 338. In this example, intermediate feature map 332 is generated based on input feature map 330, intermediate feature map 334 is generated based on intermediate feature map 332, intermediate feature map 336 is generated based on both intermediate feature map 334 and on intermediate feature map 332, and output feature map 338 is generated based on both intermediate feature map 336 and input feature map 330. In particular embodiments, such as in AR/VR applications, the input and output feature maps may have similar sizes and shapes, while the sizes and shapes of the intermediate feature maps may vary widely. For example, in some cases, a particular intermediate feature map may be shorter, narrower, and/or shallower than the preceding feature map(s) from which it was generated, while in other cases, a particular feature map may be taller, wider, and/or deeper than the preceding feature map(s) from which it was generated.

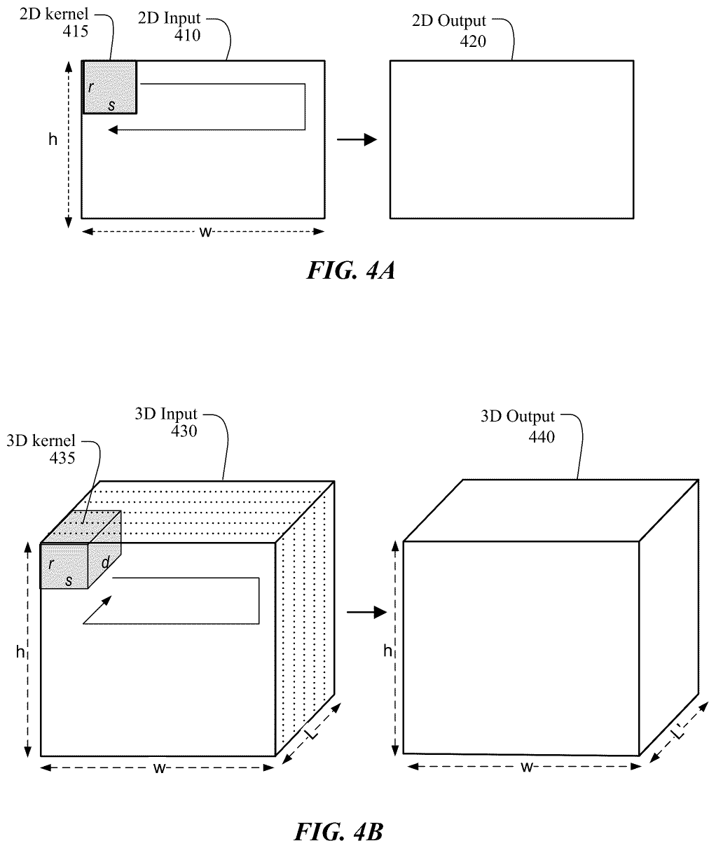

FIGS. 4A and 4B illustrate the operation of example convolutional layers in respective CNNs. More specifically, FIG. 4A illustrates a 2D convolution operation performed by a single convolutional layer of a CNN and FIG. 4B illustrates a 3D convolution operation performed by a single convolutional layer of a CNN. In these and other examples, video clips input to a CNN may be referred to as having a size of h×w×L×c where c is the number of channels, L is number of frames in an input image frame stack to which convolution operations are applied, and h and w are the height and width of each image frame, respectively. In these and other examples, 3D convolution and pooling kernel sizes may be indicated as r×s×d, where d represents the kernel temporal depth (i.e., the number of image frames in the input image stack to which the kernel is applied) and r×s represents the spatial dimensions of the kernel.

In the example illustrated in FIG. 4A, a 2D convolution applied to 2D input image frame 410 will generate a 2D output image frame 420. In some embodiments, the 2D input image frame 410 and the 2D output image frame 420 may include image data in three color channels (e.g., RGB channels). In the illustrated example, the input image frame 410 is of size h×w, a 2D filter kernel 415 is of size r×s (e.g., 3×3), and the 2D convolution operation includes taking the 2D filter kernel 415 and convolving it spatially by sweeping across and then down the input image frame 410, as shown, to generate the 2D output image frame 420. For example, each 2D filter kernel 415 may be represented as an r×s grid of weights to be convolved with a similarly sized collection of features within 2D input image frame 410. If there are three color channels in the image data, there may be three different 2D filter kernels 415 that are applied in the same manner to the 2D input image frame 410, i.e., one 2D filter kernel 415 for each color channel, to generate image data for the 2D output image frame 420 in the three color channels. For example, each 2D filter kernel 415 may provide the weights that are multiplied by respective values of the elements in an r×s sized portion of the elements of a respective color channel of 2D input image frame 410. In this example, the convolution operation is a spatial convolution in 2D, and does not include a temporal component. Therefore, any temporal information included in the input signal is lost following the 2D convolution operation.

In the example illustrated in FIG. 4B, a 3D convolution applied to a 3D input image frame stack 430 will generate a 3D output image frame volume 440, while preserving temporal information of the input signal. In the illustrated example, the 3D input image frame stack 430 is of size h×w×L, where L represents the number of frames in the input image frame stack 430. As described in more detail herein, the 3D input image frame stack 430 may include a target pair of consecutive input image frames and one or more additional input image frames immediately preceding and following the target pair of consecutive input image frames to provide additional context. In this example, a 3D filter kernel 435 is of size r×s×d (e.g., 3×3×3), where d represents the kernel temporal depth and d<L. The 3D convolution operation includes applying the 3D filter kernel 435 to each location in 3D space (h×w×L) by convolving it both spatially and temporally across the 3D input image frame stack 430, sweeping from left to right, then top to bottom, and then in the depth (or temporal) dimension, as shown, to generate the 3D output image frame volume 440. For example, each 3D filter kernel 435 may be represented as an r×s×d grid of weights to be convolved with a similarly sized collection of features within 3D input image frame stack 430. The use of such 3D space-time convolution preserves the temporal information of the input signals when generating the output volume. In various embodiments, the output image frame volume 440 may include image data for multiple interpolated image frames to be inserted between the target pair of image frames in input image frame stack 430. If there are three color channels, there may be three different 3D filter kernels 435 that are applied in the same manner to the 3D input image frame stack 430, i.e., one 3D filter kernel 435 for each color channel, to generate image data for the 3D output image frame volume 440 in the three color channels. For example, each 3D filter kernel 435 may provide the weights that are multiplied by respective values of the elements in an r×s×d sized portion of the elements of a respective color channel of 3D input image frame stack 430.

Video frame interpolation is a challenging problem in video analysis that aims to overcome the limited acquisition frame rate and exposure time of commercial video cameras, where the task is to generate non-existent intermediate frames between existing ones. With k as the interpolation factor, the k×-video frame interpolation problem is to predict (k−1) additional intermediate frames for every original frame of the input video that are both spatially and temporally consistent with the rest of the video. A large number of existing approaches use bidirectional flow warping for frame interpolation, where the input frames are used to estimate bidirectional optical flow maps from a reliable flow estimator network, possibly along with additional information like monocular depth maps and occlusion masks. The interpolated frames at intermediate time steps are then generated either by using backward or forward warping. However, the optical flow-based approaches, as well as proposed alternatives, have to confront one or more of the following limitations: (1) Computational Inefficiency. Since they rely on optical flow and pixel level warping procedures, these approaches are inefficient at both training and inference making them less suitable for many applications. (2) Modeling Complex Trajectories. The modeling capacity of these approaches is limited to account for only linear or quadratic motion trajectories and extending these to account for more complex motions is non-trivial, and (3) Representation Inflexibility. By accepting pre-computed optical flows as inputs, these approaches focus on learning only spatial warping and interpolation. Thus, the representations learned in the process are not useful beyond frame interpolation.

In particular embodiments, the methods described herein for video frame interpolation using 3D space-time convolutions jointly address the aforementioned limitations in a simple yet efficient CNN architecture that utilizes space-time convolutions for predicting intermediate frames of a video. Without demanding access to external flow or depth maps, this model is able to make single-shot, end-to-end multiple-frame predictions. It naturally handles complex motions and occlusions through learning from large scale video data, significantly boosts inference speed compared to current fastest approaches, while outperforming many existing interpolation methods by a considerable margin. The model is also robust to different frame rates of the original input video which, when combined with its faster inference speed, makes it particularly useful for real time applications.

In particular embodiments, models learned from video may be able to simultaneously reason about intricate synergy between objects, motions, and actions for accurate frame interpolation. This is because different actions and objects have different motion signatures, and these properties may be precisely captured through the representations learned for accurate video frame interpolation. For example, in particular embodiments, the video frame interpolation method described herein may be used as a pretext task to learn spatio-temporal representations from large scale unlabeled video. The validity of this approach has been demonstrated through improved performance on action recognition and optical flow estimation tasks compared with a training-from-scratch baseline as well as with other self-supervised approaches based on pixel level pretext tasks.

The 3D CNN architecture for video frame interpolation described herein is an efficient and flow-agnostic architecture that can model complex motions and is able to make single-shot multiple-frame predictions. Unlike most existing work in this domain, which take only two image frames as input, this architecture accepts an arbitrary number of additional image frames as input to provide additional context, leading to improved results. For example, by using only two input image frames for a video frame interpolation, existing systems can only assume that a difference between the two image frames is due to a linear motion. However, the difference may represent a small portion of a more complex motion, such one having a non-linear (e.g., curved) trajectory. By incorporating a longer context into the input for a video frame interpolation, such trajectories can be detected, and corresponding intermediate positions can be predicted and reflected in the frames generated by the video interpolation network. For example, including the additional temporal dimension into the interpolation may be useful in modeling temporal abstractions such as motion trajectories, actions, or correspondences between frames in the video input. In addition, the video frame interpolation networks described herein may learn useful representations along the temporal dimensions that can be reused in downstream tasks, such as like action recognition, with limited labeled data. In some experiments, it was determined that, for many applications, including one or two additional image frames immediately preceding and one or two additional image frames immediately following a target pair of frames between which interpolated frames are to be inserted was sufficient to significantly improve image quality, while the overhead to extend the image stack beyond one or two additional frames before and after the target pair might not be worth may further incremental improvement.

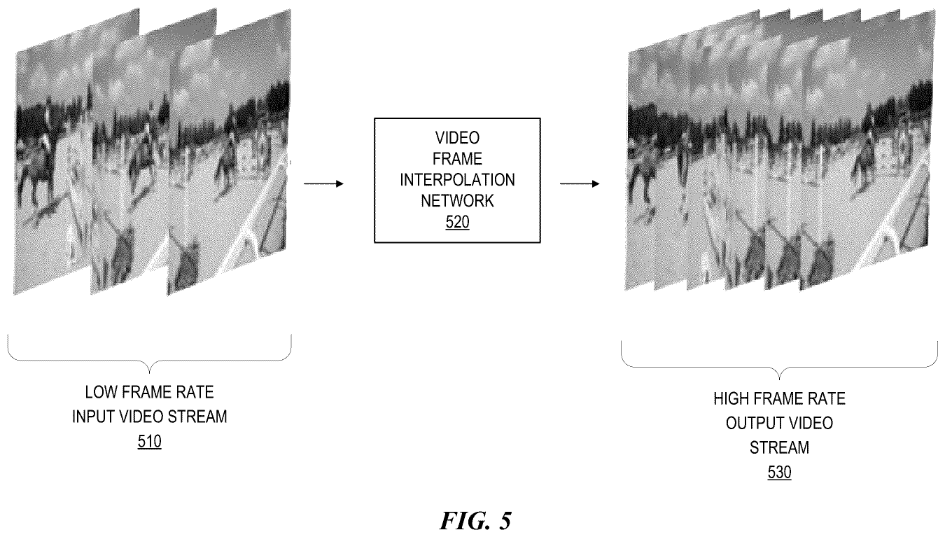

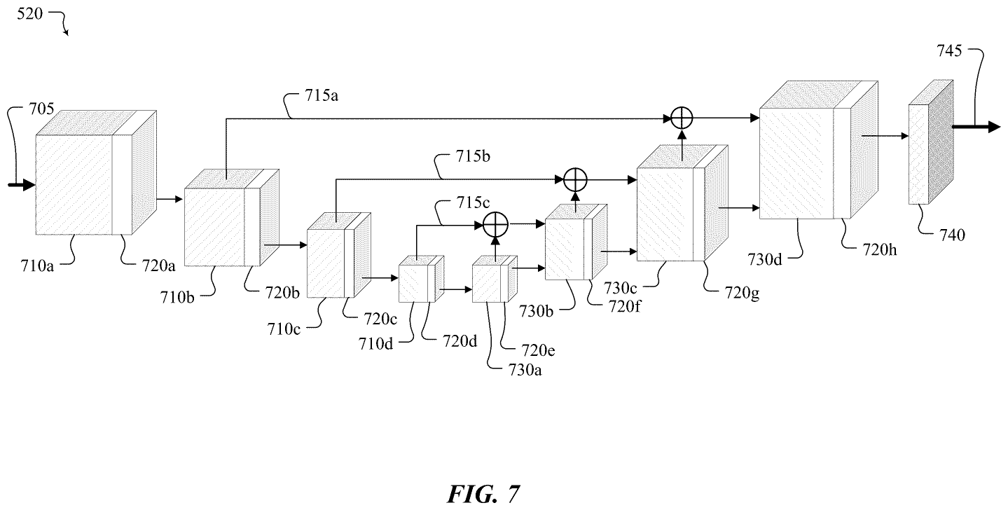

FIG. 5 illustrates an example video interpolation using a video frame interpolation network. In this example, a portion of a low frame rate input video stream 510 is input to a video frame interpolation network 520. The video frame interpolation network 520 then generates and output a higher frame rate output video stream, a portion of which is shown as high frame rate output video stream 530. For example, if a low frame rate input video stream 510 having a frame rate of f frames-per-second is input to video frame interpolation network 520, a high frame rate output video stream 530 may be output in which the frame rate is increased by a factor of 2×, 4×, or 8×, by generating and inserting 1, 3, or 7 additional interpolated frames, respectively, in between each pair of consecutive image frames in the low frame rate input video stream 510. An example video frame interpolation network 520 is illustrated in FIG. 7 and described in more detail below. In general, the video frame interpolation network 520 may accept input video streams having any arbitrary frame rate and may be used to increase the frame rate of the input video stream 510 by any arbitrary amount.

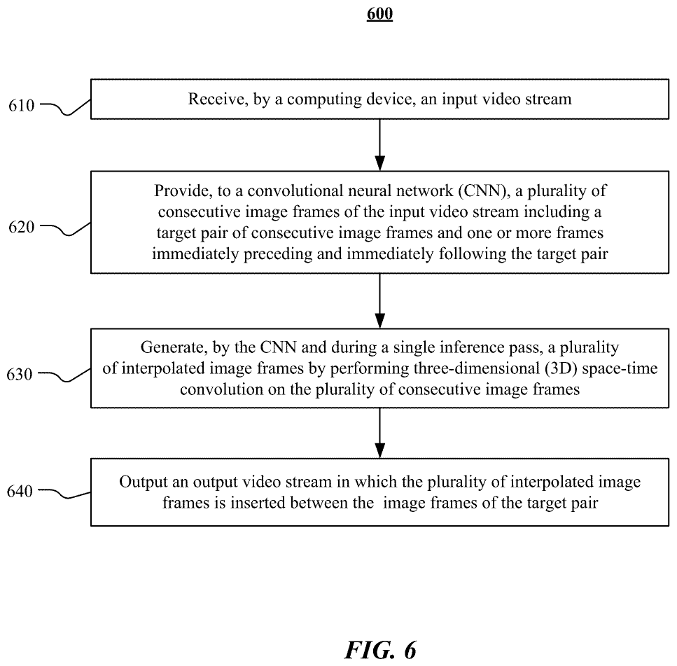

FIG. 6 illustrates selected elements of an example method 600 for video frame interpolation. The method may begin at step 610 with receiving, by a computing device, an input video stream.

At step 620, the method may include providing, to a convolutional neural network (CNN), a plurality of consecutive image frames of the input video stream including a target pair of consecutive image frames and one or more frames immediately preceding and immediately following the target pair. In some embodiments, the plurality of consecutive image frames may include a single image frame immediately preceding the target pair and a single image frame immediately following the target pair. In other embodiments, the plurality of consecutive image frames may include two or more consecutive image frames immediately preceding the target pair and two or more consecutive image frames immediately following the target pair. As discussed above, these additional image frames may provide additional context to the interpolation operation, leading to improved results over existing approaches. For example, by incorporating a longer context into the input for a video frame interpolation, non-linear and other complex trajectories can be detected in the video stream, and corresponding intermediate positions can be predicted and reflected in the frames generated by the video interpolation network.

At step 630, method 600 may include generating, by the CNN and during a single inference pass (e.g., a single forward pass), a plurality of interpolated image frames by performing three-dimensional (3D) space-time convolution on the plurality of consecutive image frames, as described in more detail herein. At step 640, the method may include outputting an output video stream in which the plurality of interpolated image frames is inserted between the image frames of the target pair.

Although this disclosure describes and illustrates particular steps of the method of FIG. 6 as occurring in a particular order, this disclosure contemplates any suitable steps of the method of FIG. 6 occurring in any suitable order. Moreover, although this disclosure describes and illustrates an example method for video frame interpolation including the particular steps of the method of FIG. 6, this disclosure contemplates any suitable method for video frame interpolation including any suitable steps, which may include all, some, or none of the steps of the method of FIG. 6, where appropriate. Furthermore, although this disclosure describes and illustrates particular components, devices, or systems carrying out particular steps of the method of FIG. 6, this disclosure contemplates any suitable combination of any suitable components, devices, or systems carrying out any suitable steps of the method of FIG. 6.

Particular embodiments may repeat one or more steps of the method of FIG. 6, where appropriate. More particularly, the operations shown as steps 620 and 630 may be repeated with each pair of consecutive image frames in a sliding window being input to the CNN to generate interpolated frames to be inserted between the image frames of the pair, such that the frame rate for the input video steam as a whole is increased by a desired factor. For example, method 600 may include providing, to the CNN, a second plurality of consecutive image frames of the input video stream including a second target pair of two consecutive image frames, at least one image frame immediately preceding the second target pair, and at least one image frame immediately following the second target pair, and generating, by the CNN, a second plurality of interpolated image frames by performing 3D space-time convolution on the second plurality of consecutive image frames, and so on for each additional pair of consecutive image frames in the input video stream. In this manner, the output video stream may include a respective plurality of interpolated image frames inserted between each pair of consecutive image frames in the input video stream. In addition, the operations of method 600 shown in FIG. 6 may be repeated, or may be performed in parallel, for image data in multiple channels, e.g., multiple color changes. For example, the plurality of consecutive image frames may include image data in a plurality of channels, and generating the plurality of interpolated image frames may include generating, by respective convolutional layers of the CNN, image data for each of a plurality of channels of the plurality of interpolated image frames based on image data in one or more of the plurality of channels in the plurality of consecutive image frames. In embodiments in which the plurality of channels comprises a plurality of color channels, each of the respective convolutional layers of the CNN may operate on image data in one of the color channels.

In particular embodiments, the architecture of the 3D video interpolation networks may include some elements of the popular 2D U-Net used in pixel generation tasks. However, all the 2D convolutions in the encoder and decoder of the 2D U-Net may be replaced in the 3D video interpolation networks with 3D convolutions. The 3D convolutions of the 3D video interpolation networks may be used to accurately model the temporal dynamics between the input frames, invariably resulting in better interpolation quality than is possible using existing approaches. In particular embodiments, each 3D filter may be thought of as a 5-dimensional filter of size h×w×cᵢ×cₒ×d, where d represents the temporal size of the kernel, h×w is the spatial size of the kernel, and cᵢ and cₒ represent the number of input and output channels in the layer, respectively. While any of a variety of 3D CNN architectures may be used as the encoder, in particular embodiments, the encoder may include a ResNet-3D with 18 layers (R3D-18), in order to strike a balance between complexity and accuracy. In particular embodiments, the last classification layer may be removed from R3D-18, resulting in five convolution blocks, each made up of two 3D convolutional layers and a skip connection. In other embodiments, such as that illustrated in FIG. 7 and described below, the encoder may include a different number of convolution blocks. All convolution kernels may have a size of d, where d is the kernel temporal depth, and all of the convolution layers may be applied with appropriate padding (both spatial and temporal) and stride 1. Thus, there may be no change in terms of size from the input to the output of these convolution layers. In particular embodiments, all temporal striding may be removed, since down-sampling operations like striding and pooling may remove details that are crucial for generating sharper images. However, a spatial stride of 1 may be used in some blocks of the network to keep the computation manageable.

In particular embodiments, the decoder may essentially construct the interpolated output frames from a deep latent representation by progressive, multi-scale feature up-sampling and feature fusion from the encoder. For up-sampling, 3D transpose convolution layers (3DTransConv) with a stride of 2 may be used. To handle the commonly observed checkerboard artefacts, a 3DConv layer may be added after the last 3DTransConv layer. The decoder may also include skip connections that directly combine encoder features with the corresponding decoder along the channels to fuse the low-level and high-level information necessary for accurate and sharp interpolation. The output of the decoder, which is a 3D feature map, may then be passed through a temporal fusion layer, implemented by a 2D convolution, in which the features from the temporal dimension are concatenated along the channels resulting in a 2D spatial feature map. This may help to aggregate and merge information present in multiple frames for prediction. Finally, this output may be passed through a 7×7 2D convolution kernel that predicts an output of size H×W×3(k−1), which is then split along the channel dimension to obtain the (k−1) output frames.

FIG. 7 illustrates selected elements of an example video frame interpolation network 520 including a CNN. As described above, the example video frame interpolation network 520 includes a U-Net style architecture with 3D space-time convolutions and deconvolutions. In this example architecture, input 705 represents an input video stream, image frames of which pass through multiple neural network layers that compute multiple representation layers on which it is much easier to perform subsequent computations than on the raw video data, and the output 745 is a collection of interpolated frames, all of which are generated in a single inference pass (e.g., a single forward pass). By contrast, in some existing video interpolation approaches, if 7 intermediate frames are to be added in between a target pair of consecutive image frames, one intermediate frame is predicted and output at a time during its own forward pass through a neural network.

In the illustrated example, elements 710a-710d are 3D convolution layers (3D cony), and the number of filters for these convolution layers from 710a to 710d are 64, 128, 256, and 512, respectively. The video frame data passes through multiple ones of these 3D cony layers, and the outputs are also video frames. As the video frame data passes through each of the convolution layers, the 3D space/time dimensions (H, W, and L), which include a lot of redundant information that can be compressed, get smaller and smaller at each layer, but the channel dimension, where many of the most useful details are found, gets larger.

In the illustrated example, the CNN includes channel gating after all convolution layers 710 and de-convolution layers 730. For example, elements 720a-720h are gating modules. In particular embodiments, gating modules may determine (or choose) which filters are useful for determining a given feature and which are not, similar to an “attention” technique used in neural networks. In other words, the gating modules 720 cause the network to attend to the useful parts of a filter. For example, if there are 256 filters, that would correspond to 256 channels in each block. But not all of these filters are useful for a particular video. A gating module may learn which parts of the filter network (e.g., maybe only 10 filters) are particularly useful. The gating module may boost the weight of these 10 filters and reduce (or zeros out) those that are not as useful.

In the illustrated example, 730a-730d are de-convolution layers (3D TransConv). These layers are similar to the convolution layers 710 except that they increase the resolution of the 3D space/time dimensions (H, W, and L) rather than decreasing it. In other words, in the illustrated video interpolation network, frames of an input video stream 105 are first passed through the convolution layers 710 to decrease the resolution and create an abstract understanding of the image data in the video stream, then this representation is passed through the de-convolution layers 730, which output a 3D feature map containing image data predicted to have been present in intermediate frames of the input video stream 705 if the input video stream 705 had a higher frame rate.

In the illustrated example, final prediction layer 740 represents a 2D convolution layer for projecting the 3D feature map output into (k−1) frame predictions (interpolated frames) 745, which allows the video frame interpolation network 520 to predict multiple frames in a single inference pass. In other words, final prediction layer 740 adapts the 3D output feature map generated by the convolution layers 710 and de-convolution layers 730 to the desired number of interpolated output frames. For example, for 8× interpolation, video frame interpolation network 520 predicts (k−1), i.e., 7 frames between each target pair of consecutive image frames in the input video stream 705. For 16× interpolation, video frame interpolation network 520 predicts 15 frames between each target pair of consecutive image frames in the input video stream 705. For 4× interpolation, video frame interpolation network 520 predicts only 3 frames between each target pair of consecutive image frames in the input video stream 705. In particular embodiments, final prediction layer 740 generate an output tensor with any number of output channels from the 3D output feature map generated by the convolution layers 710 and de-convolution layers 730, where all the information learned by the convolution layers 710 and de-convolution layers 730 is concatenated in the output tensor, and then divide the output tensor up into the newly interpolated intermediate frames. In one example, for an interpolation factor, k, final prediction layer 740 may perform a 2D convolution on the output of the convolution layers 710 and de-convolution layers 730 to predict an output tensor of size (k−1)×H×W, with 3 channels, and then divide that output tensor into k−1 chunks, each representing an interpolated 2D image frame with 3 channels.

In the illustrated example, the CNN includes skip connections 715a-715c between particular elements of the encoder and the decoder. For example, the encoder may compute some high-level detail in the image data, e.g., the color, and the decoder may receive as input a very compressed version of the input. As shown in FIG. 7, the final convolution layers 710 represents the most compressed version of the input, which is typically not enough to recover all the low-level details. Therefore, in the illustrated example, the CNN is configured to feed some information forward (outside the normal pipeline of the encoder/decoder) using skip connections. In this way, the decoder gets high-level details from the compressed versions of the input that are generated by each convolution layer 710 and fed forward, as well as low-level details from the skip connections, both of which are useful for accurate interpolation.

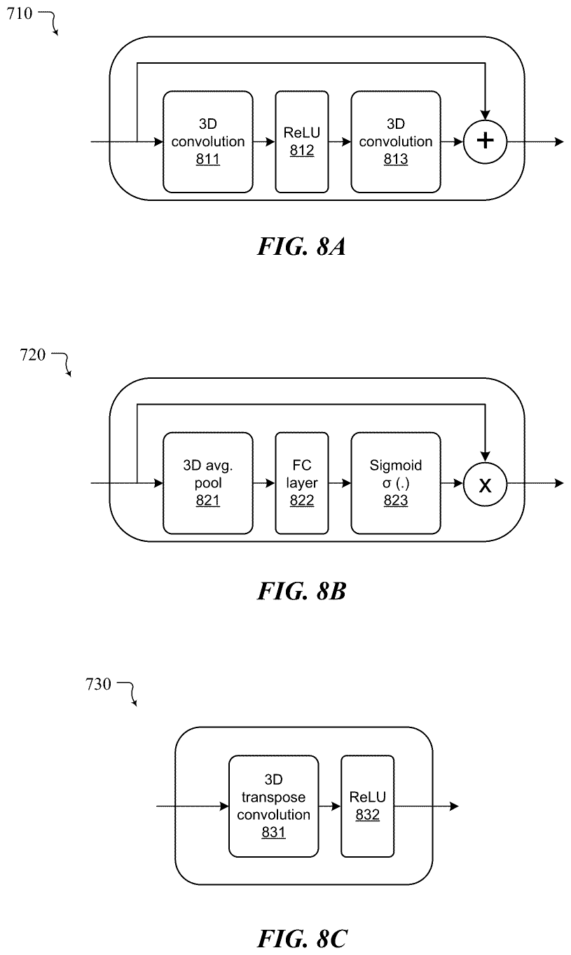

FIGS. 8A through 8C illustrate respective elements of the example video frame interpolation network shown in FIG. 7. For example, FIG. 8A illustrates an example 3D convolution layer 710 (3D cony), which includes two 3D convolution elements 811 and 813, a ReLU element 812, and a skip connection between its input and its output. FIG. 8B illustrates an example gating module 720. As described above, in particular embodiments, spatio-temporal feature gating may be applied after every layer in the video frame interpolation network 520. In general, feature gating technique used as a form of self-attention mechanism in deep neural networks for action recognition, image classification, and video interpolation. Given an intermediate feature dimension of size fᵢ=C×T×H×W, the output of the gating layer f₀ is given by f₀=σ(W.pool(fᵢ)+b) where W∈ [symbol] ^{C×C} and b∈ [symbol] ^{C} are learnable weight and bias parameters and pool is a spatio-temporal pooling layer. Such a feature gating mechanism may learn to upweight certain relevant dimensions of the feature maps that provide useful cues for frame interpolation, such as motion boundaries. In this example, gating module 720 includes a 3D average pooling element 821, a fully connected (FC) element 822, a Sigmoid function element 823, and a skip connection between its input and its output. FIG. 8C illustrates an example deconvolution layer 730 (3D TransConv), which includes a 3D transpose convolution element 831 and a ReLU element 832.

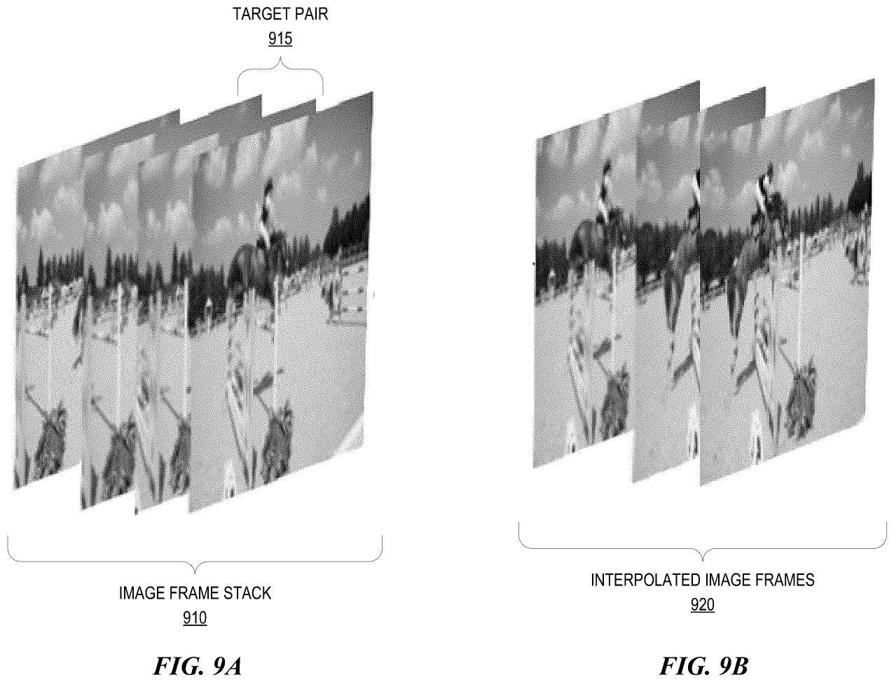

FIG. 9A illustrates an example image frame stack input to a video frame interpolation network, shown as image frame stack 910. In this example, the image frame stack 910, includes a target pair of consecutive images of an input video stream, shown as target pair 915, one additional image frame immediately preceding the target pair 915, and one additional image frame immediately following the target pair 915.

FIG. 9B illustrates three example interpolated image frames output by a video frame interpolation network such as those described herein based on the input image frame stack shown in FIG. 9A. For example, the video frame interpolation network may be similar to video frame interpolation network 520 and may perform 3D space-time convolution to generate interpolated frames from an image stack that includes a target pair of consecutive frames and additional frames for further context. The interpolated image frames 920, when inserted between the target pair 915, would increase the frame rate of the portion of the input video stream shown as shown as image frame stack 910 by a factor of 4.

In particular embodiments, a video frame interpolation network such as video frame interpolation network 520 may be trained to predict multiple interpolated image frames in a single inference pass using sampled training data from unlabeled videos. For example, inputs and ground truths required for training the network may be generated directly from raw videos as follows. Let k be the interpolation factor, and let V be an original unlabeled video with a frame rate off frames-per-second (fps). In order to generate training data for a k×video frame interpolation problem, frames of V may be sub-sampled with a sampling stride of k to form a low frame rate video V′ with a frame rate of f/k fps. Then, to perform interpolation between any two frames Aᵢ, Aᵢ₊₁ of V, a temporal window of size 2C centered around Aᵢ and Aᵢ₊₁ may be provided as the input, and all frames between Aᵢ and Aᵢ₊₁ in original video V may be used as the ground truth. In particular embodiments, video frame interpolation network 520 may be flexible enough to handle any temporal context instead of just Aᵢ, Aᵢ₊₁, which helps with modelling complex trajectories and improves interpolation accuracy. The sampled input frames are concatenated in the temporal dimension, resulting in input dimensions 2C×H×W×3, where H and W are the spatial dimensions of the input video frames. In various experiments, it was discovered that, for most common settings, using four context frames (C=2) is sufficient for accurate prediction.

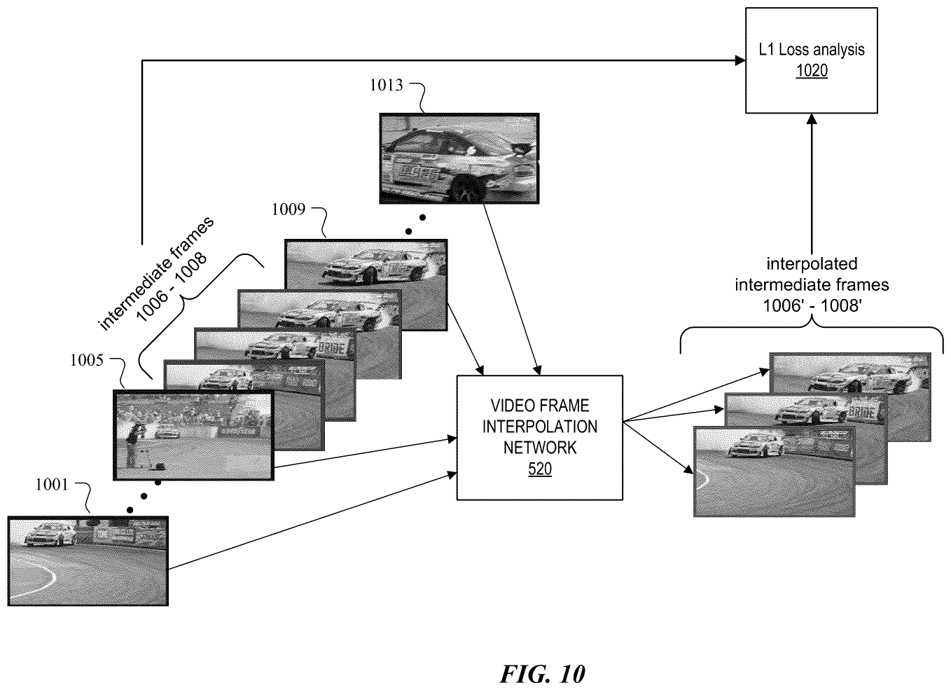

FIG. 10 illustrates the use of video frame sampling for training a video frame interpolation network. More specifically, FIG. 10 illustrates this sampling procedure for the case of a 4× interpolation (k=4) with two context inputs from the past and future (C=2). In this case, sub-sampled frames of an input video stream corresponding to {A₁, A₅, A₉, A₁₃} are used as inputs to predict three intermediate frames corresponding to {A₆, A₇, A₈}. Intuitively, the frames in the immediate neighborhood of a target pair of image frames would be expected to be more relevant for frame interpolation than frames that are farther away. In FIG. 10, a temporal window of thirteen image frames 1001-1010 of an original unlabeled video stream is shown. During the training phase, for 4× interpolation, the original unlabeled video stream is sub-sampled every fourth frame (i.e., 1001, 1005, 1009, 1013) to provide a low frame rate training video input to video frame interpolation network 520. In this example, for a target pair of consecutive image frames in the training video (i.e., image frames 1005 and 1009), video frame interpolation network 520 may predict the three intermediate frames 1006-1008 between image frames 1005 and 1009 in the original unlabeled video by performing 3D space-time convolutions on an image stack including image frames 1001, 1005, 1009, and 1013, and output the predicted intermediate frames shown as interpolated frames 1006′-1008′.

In particular embodiments, the whole video frame interpolation network 520 may be trained end-to-end using a loss analysis, shown as L1 loss analysis 1020. For example, interpolated image frames 1006′-1008′ may be compared to ground truth (i.e., original image frames 1006-1008) using L1 loss analysis 1020, after which video frame interpolation network 520 may be refined based on the results of the comparison. In other words, L1 loss analysis 1020 may be used to determine the differences between what was predicted and what should have been predicted and the network may learn to output intermediate frames that are closer to what would be observed in actual high-frame-rate video. In particular embodiments, L1 loss analysis 1020 may apply the following equation:

$$L ( \{ \hat{I} \} , \{ I \} ) = \frac{1}{N} {\sum }_{i = 1}^{N} {\sum }_{j = 1}^{k - 1} {‖ \hat{{I}_{j}} - {I}_{j} ‖}_{1} \qquad ( 1 )$$

In equation (1), and {Îⱼ} may represent the j^{th} predicted and the j^{th} ground truth frames, respectively, out of the (k−1) target frames, k may represent the interpolation factor, and N may represent the size of a mini-batch used in training. In particular embodiments, this approach may be scaled to train the video frame interpolation network 520 for any interpolation ratio (e.g., 2×, 4×, 8×, etc.). In at least some embodiments, random frame order reversal and random horizontal flipping may be employed as augmentation strategies on the datasets during training. The trained neural network may then, when presented with low-frame-rate-video during the inference phase, generate reasonable intermediate frames similar to what would be included in actual higher-frame-rate videos.

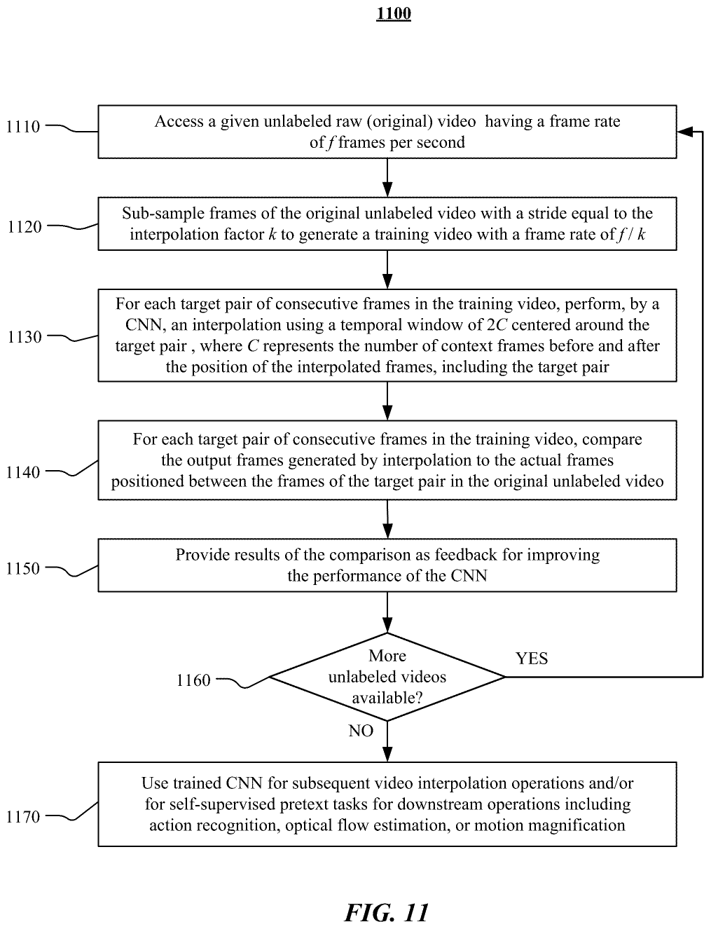

FIG. 11 illustrates an example method 1100 for training a video frame interpolation network. The method may begin at step 1110, with accessing a given unlabeled raw (original) video having a frame rate off frames per second. At step 1120, the method may include sub-sampling frames of the original unlabeled video with a stride equal to the interpolation factor k to generate a training video with a frame rate of f/k frames-per-second.

At step 1130, method 1100 may include, for each target pair of consecutive frames in the training video, performing, by a CNN, an interpolation using a temporal window of 2C centered around the target pair, where C represents the number of context frames before and after the position of the interpolated frames, including the target pair.

At step 1140, the method may include, for each target pair of consecutive frames in the training video, comparing the output frames generated by interpolation to the actual frames positioned between the frames of the target pair in the original unlabeled video. At step 1150, method 1100 may include providing results of the comparison as feedback for improving the performance of the CNN.

If, at step 1160, there are more unlabeled videos available for training, the method may include repeating steps 1110-1150 for each additional video. If, or once, there are no additional unlabeled videos available for training, method 1100 may proceed to step 1170, where the trained CNN is used for subsequent video interpolation operations and/or for self-supervised pretext tasks for downstream operations including action recognition, optical flow estimation, or motion magnification.

Particular embodiments may repeat one or more steps of the method of FIG. 11, where appropriate. For example, the operations of method 1100 shown in FIG. 11 may be repeated, or may be performed in parallel, for image data in multiple channels, e.g., multiple color changes. For example, the plurality of consecutive image frames in the training video may include image data in a plurality of channels, and generating the plurality of interpolated image frames may include generating, by respective convolutional layers of the CNN, image data for each of a plurality of channels of the plurality of interpolated image frames based on image data in one or more of the plurality of channels in the plurality of consecutive image frames. In embodiments in which the plurality of channels comprises a plurality of color channels, each of the respective convolutional layers of the CNN may operate on image data in one of the color channels.

Although this disclosure describes and illustrates particular steps of the method of FIG. 11 as occurring in a particular order, this disclosure contemplates any suitable steps of the method of FIG. 11 occurring in any suitable order. Moreover, although this disclosure describes and illustrates an example method for training a video frame interpolation network including the particular steps of the method of FIG. 11, this disclosure contemplates any suitable method for training a video frame interpolation network including any suitable steps, which may include all, some, or none of the steps of the method of FIG. 11, where appropriate. Furthermore, although this disclosure describes and illustrates particular components, devices, or systems carrying out particular steps of the method of FIG. 11, this disclosure contemplates any suitable combination of any suitable components, devices, or systems carrying out any suitable steps of the method of FIG. 11.

It has been demonstrated that the representations learned by the video frame interpolation networks described herein may be useful for a variety of downstream tasks. For example, in order to successfully predict intermediate frames, it is essential for the video frame interpolation networks described herein to accurately reason about motion trajectories, to estimate and capture motion patterns specific to objects, and to reconstruct both high-level semantic detail and low-level texture details. In particular embodiments, the types of motion information learned by the network and the corresponding feature representations generated by the network may be useful for other video analytics tasks. For example, video frame interpolation may be used in the context of unsupervised representation learning by pre-training a network on the task of frame interpolation and reusing the learned feature representations for the tasks of action recognition, optical flow estimation, and/or motion magnification, among other tasks.

In one example, for downstream experiments on action recognition, the pretrained encoder of the network may be used along with a classifier (including, e.g., a global average pooling layer, a fully connected layer, and a softmax layer) for training on downstream actions, adding a temporal stride of 4. The network may be fine-tuned using stochastic gradient descent with batch normalization. During inference, groups of consecutive overlapping clips may be sampled from a test video and predictions may be averaged over all of the clips.

In another example, a network trained to perform video frame interpolation using 3D space-time convolution, as described herein, may subsequently be fine-tuned for optical flow estimation. Fine-tuning using the trained network may achieve much lower end point error (EPE) compared with random initialization using the same backbone architecture, proving that this model learns useful flow features. One point to consider in downstream training on optical flow is that the flow networks generally take only two input frames, which may be considered too few for a 3D CNN. Nevertheless, to examine the effectiveness of features learned using frame interpolation for optical flow, the same encoder and decoder may be used, and the last prediction layer may be initialized to output two channels instead, corresponding to x and y values of flow at each pixel. Since the interpolation network was trained to take 4-frame inputs, copy padding may be applied to the inputs, e.g., repeating each input frame two times. An EPE loss function may be used when training the network. A comparison between this approach and other approaches for optical flow prediction showed that pre-training a network to perform video frame interpolation using 3D space-time convolution may help to reduce the EPE by 6.01 and 5.14 on various benchmark datasets, compared with training from scratch on the same backbone architecture.

Motion magnification is a complementary problem to frame interpolation in which the task is to magnify subtle motions from the input video that are difficult to see with the naked eye or normal camera, such as a baby breathing. With a magnifying effect, such subtle motions can be made more visible. In particular embodiments, by training a CNN to use the techniques described herein for video frame interpolation, the CNN can understand, or “see”, the behavior of a motion even if it is too small for a human to see, after which the motion can be magnified based on the actual motion vector. More specifically, motion magnification may be defined follows. For an Image I(x,t)=f(x+δ(x,t)), the goal of motion magnification is to generate an output image Ĩ(x,t) such that, for a magnification factor α:

I(x,t)=f(x+(1+α)δ(x,t)) (2)

For frame interpolation, α<1, since interpolation involves determining what happens between two frames, while for motion magnification, α>1, since the goal is to extrapolate existing motions beyond the visible regime. In particular embodiments, the magnitude of the motion vector may be increased by a factor of 10 or 100 while the direction and frequency remain the same as in the actual small motion, thus exaggerating the motion. Experiments in which a network was trained to perform video frame interpolation using 3D space-time convolution and subsequently fine-tuned to perform motion magnification with a fixed magnification factor of 10, showed that the motion magnification performance was improved when using the trained network than when using a random pre-trained network.

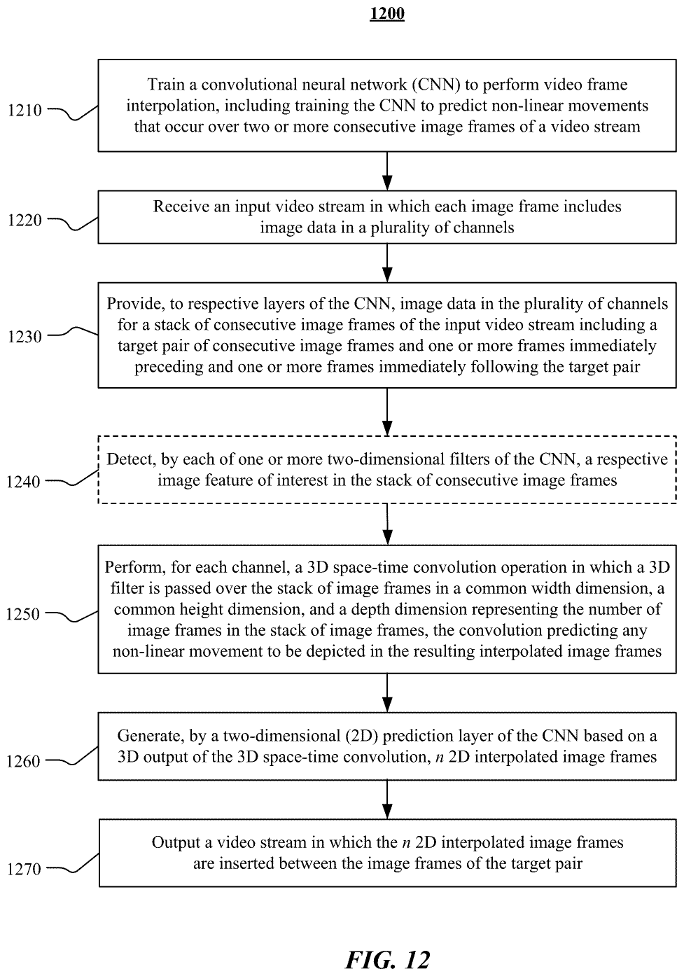

FIG. 12 illustrates an example method 1200 for video interpolation using a trained video frame interpolation network. The method may begin at step 1210, where a convolutional neural network (CNN) is trained to perform video frame interpolation. This may include training the CNN to predict non-linear movements that occur over two or more consecutive image frames of a video stream. At step 1220, method 1200 may include receiving an input video stream in which each image frame includes image data in a plurality of channels.

At step 1230, the method may include providing, to respective layers of the CNN, image data in the plurality of channels for a stack of consecutive image frames of the input video stream including a target pair of consecutive image frames and one or more frames immediately preceding and one or more frames immediately following the target pair.

At step 1240, the method may (optionally) include detecting, by each of one or more two-dimensional (2D) filters of the CNN, a respective image feature of interest in the stack of consecutive image frames. For example, the CNN may include 2D filters for detecting edges, colors, textures, shapes, and/or semantics of various paths and objects depicted in the image data. In particular embodiments, the 3D filters described above in reference to video interpolation network 520 may capture this type of information instead of, or in addition to, any separate and distinct 2D filters in the CNN. However, in addition to this information, the 3D filters described above may also capture motions and interactions between the objects and other features specific to video that can be used to predict actions and/or the paths of various objects in the video.

At step 1250, method 1200 may include performing, for each channel, a 3D space-time convolution operation in which a 3D filter is passed over the stack of consecutive image frames in a width dimension common to each of the image frames in the stack of image frames, a height dimension common to each of the image frames in the stack of image frames, and a depth dimension representing the number of image frames in the stack of image frames, the convolution predicting any non-linear movement to be depicted in the resulting interpolated image frames. For example, generating the interpolated image frames may include generating, by respective convolutional layers of the CNN, image data for each of a plurality of channels of the interpolated image frames based on image data in one or more of the plurality of channels in the stack of consecutive image frames. In some embodiments, the plurality of channels may include a plurality of color channels, e.g., RGB channels, and each of the respective convolutional layers of the CNN may operate on image data in one of the color channels.

At step 1260, the method may include generating, by a two-dimensional (2D) prediction layer of the CNN based on a 3D output of the 3D space-time convolution, n 2D interpolated image frames. For example, if the number of interpolated image frames is a predetermined number n, the insertion of n interpolated image frames between each target pair of consecutive image frames in the input video stream would increase the frame rate of the output video stream compared to the frame rate of the input video stream by a factor of (n+1).

At step 1270, method 1200 may include outputting a video stream in which the n 2D interpolated image frames are inserted between the image frames of the target pair. Particular embodiments may repeat one or more steps of the method of FIG. 12, where appropriate. For example, as discussed above in reference to method 600 illustrated in FIG. 6, the operations shown as steps 1220 through 1260 may be repeated with each pair of consecutive image frames in a sliding window being input to the CNN to generate interpolated frames to be inserted between the image frames of the pair, such that the frame rate for the input video steam as a whole is increased by a desired factor.

Although this disclosure describes and illustrates particular steps of the method of FIG. 12 as occurring in a particular order, this disclosure contemplates any suitable steps of the method of FIG. 12 occurring in any suitable order. Moreover, although this disclosure describes and illustrates an example method for video interpolation using a trained video frame interpolation network including the particular steps of the method of FIG. 12, this disclosure contemplates any suitable method for video interpolation using a trained video frame interpolation network including any suitable steps, which may include all, some, or none of the steps of the method of FIG. 12, where appropriate. Furthermore, although this disclosure describes and illustrates particular components, devices, or systems carrying out particular steps of the method of FIG. $, this disclosure contemplates any suitable combination of any suitable components, devices, or systems carrying out any suitable steps of the method of FIG. 12.

One major challenge for realizing the applications of video frame interpolation for real time applications on low resource hardware is to optimize the trade-off between faster inference speed and better interpolation quality. The video frame interpolation networks described herein may, in particular embodiments, strike an optimum balance between these factors by achieving the best performance with the shortest runtime. In fact, in some experiments, the disclosed networks achieved an inference speed higher than all the established methods. This improvement is possible largely because the disclosed networks require no overhead in terms of computing optical flow or depth, and all of the output frames are predicted in a single forward inference pass. Other experiments have shown that the inference speed using the disclosed networks scales gracefully with an increase in the interpolation factor k, with significant runtime improvements for 4× and 8× interpolations compared to one of the current fastest approaches. The disclosed networks were also shown to achieve a significant runtime improvement for 2×, 4× and 8× interpolations with respect to the current most accurate method, which is possible due to their single shot flow-free prediction and efficient architecture.

In various embodiments, any of a variety of applications that include streaming video, including, e.g., a mobile computing device, such as a smartphone, tablet computer, or laptop computer, an intelligent communication device, a dedicated audio/visual communication interface, or a head-mounted display (HMD) of an AR/VR system, could potentially benefit from streaming video with a relatively low frame rate and then filling in with intermediate frames on the receiving device to generate a higher frame rate video for display, thus improving perception quality, using the video frame interpolation networks and 3D convolution methods described herein.

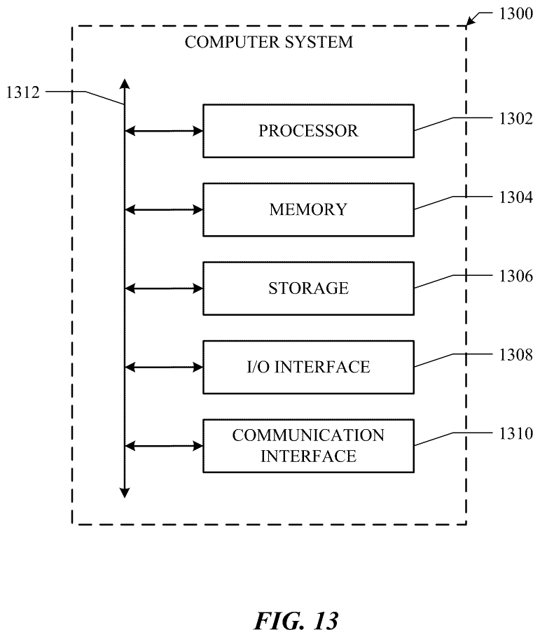

FIG. 13 illustrates an example computer system 1300. In particular embodiments, one or more computer systems 1300 perform one or more steps of one or more methods described or illustrated herein. In particular embodiments, one or more computer systems 1300 provide functionality described or illustrated herein. In particular embodiments, software running on one or more computer systems 1300 performs one or more steps of one or more methods described or illustrated herein or provides functionality described or illustrated herein. Particular embodiments include one or more portions of one or more computer systems 1300. Herein, reference to a computer system may encompass a computing device, and vice versa, where appropriate. Moreover, reference to a computer system may encompass one or more computer systems, where appropriate.

This disclosure contemplates any suitable number of computer systems 1300. This disclosure contemplates computer system 1300 taking any suitable physical form. As example and not by way of limitation, computer system 1300 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 1300 may include one or more computer systems 1300; be unitary or distributed; span multiple locations; span multiple machines; span multiple data centers; or reside in a cloud, which may include one or more cloud components in one or more networks. Where appropriate, one or more computer systems 1300 may perform without substantial spatial or temporal limitation one or more steps of one or more methods described or illustrated herein. As an example and not by way of limitation, one or more computer systems 1300 may perform in real time or in batch mode one or more steps of one or more methods described or illustrated herein. One or more computer systems 1300 may perform at different times or at different locations one or more steps of one or more methods described or illustrated herein, where appropriate.

In particular embodiments, computer system 1300 includes a processor 1302, memory 1304, storage 1306, an input/output (I/O) interface 1308, a communication interface 1310, and a bus 1312. Although this disclosure describes and illustrates a particular computer system having a particular number of particular components in a particular arrangement, this disclosure contemplates any suitable computer system having any suitable number of any suitable components in any suitable arrangement.

In particular embodiments, processor 1302 includes hardware for executing instructions, such as those making up a computer program. As an example and not by way of limitation, to execute instructions, processor 1302 may retrieve (or fetch) the instructions from an internal register, an internal cache, memory 1304, or storage 1306; decode and execute them; and then write one or more results to an internal register, an internal cache, memory 1304, or storage 1306. In particular embodiments, processor 1302 may include one or more internal caches for data, instructions, or addresses. This disclosure contemplates processor 1302 including any suitable number of any suitable internal caches, where appropriate. As an example and not by way of limitation, processor 1302 may include one or more instruction caches, one or more data caches, and one or more translation lookaside buffers (TLBs). Instructions in the instruction caches may be copies of instructions in memory 1304 or storage 1306, and the instruction caches may speed up retrieval of those instructions by processor 1302. Data in the data caches may be copies of data in memory 1304 or storage 1306 for instructions executing at processor 1302 to operate on; the results of previous instructions executed at processor 1302 for access by subsequent instructions executing at processor 1302 or for writing to memory 1304 or storage 1306; or other suitable data. The data caches may speed up read or write operations by processor 1302. The TLBs may speed up virtual-address translation for processor 1302. In particular embodiments, processor 1302 may include one or more internal registers for data, instructions, or addresses. This disclosure contemplates processor 1302 including any suitable number of any suitable internal registers, where appropriate. Where appropriate, processor 1302 may include one or more arithmetic logic units (ALUs); be a multi-core processor; or include one or more processors 1302. Although this disclosure describes and illustrates a particular processor, this disclosure contemplates any suitable processor.

In particular embodiments, memory 1304 includes main memory for storing instructions for processor 1302 to execute or data for processor 1302 to operate on. As an example and not by way of limitation, computer system 1300 may load instructions from storage 1306 or another source (such as, for example, another computer system 1300) to memory 1304. Processor 1302 may then load the instructions from memory 1304 to an internal register or internal cache. To execute the instructions, processor 1302 may retrieve the instructions from the internal register or internal cache and decode them. During or after execution of the instructions, processor 1302 may write one or more results (which may be intermediate or final results) to the internal register or internal cache. Processor 1302 may then write one or more of those results to memory 1304. In particular embodiments, processor 1302 executes only instructions in one or more internal registers or internal caches or in memory 1304 (as opposed to storage 1306 or elsewhere) and operates only on data in one or more internal registers or internal caches or in memory 1304 (as opposed to storage 1306 or elsewhere). One or more memory buses (which may each include an address bus and a data bus) may couple processor 1302 to memory 1304. Bus 1312 may include one or more memory buses, as described below. In particular embodiments, one or more memory management units (MMUs) reside between processor 1302 and memory 1304 and facilitate accesses to memory 1304 requested by processor 1302. In particular embodiments, memory 1304 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 1304 may include one or more memories 1304, where appropriate. Although this disclosure describes and illustrates particular memory, this disclosure contemplates any suitable memory.

In particular embodiments, storage 1306 includes mass storage for data or instructions. As an example and not by way of limitation, storage 1306 may include a hard disk drive (HDD), a floppy disk drive, flash memory, an optical disc, a magneto-optical disc, magnetic tape, or a Universal Serial Bus (USB) drive or a combination of two or more of these. Storage 1306 may include removable or non-removable (or fixed) media, where appropriate. Storage 1306 may be internal or external to computer system 1300, where appropriate. In particular embodiments, storage 1306 is non-volatile, solid-state memory. In particular embodiments, storage 1306 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 1306 taking any suitable physical form. Storage 1306 may include one or more storage control units facilitating communication between processor 1302 and storage 1306, where appropriate. Where appropriate, storage 1306 may include one or more storages 1306. Although this disclosure describes and illustrates particular storage, this disclosure contemplates any suitable storage.

In particular embodiments, I/O interface 1308 includes hardware, software, or both, providing one or more interfaces for communication between computer system 1300 and one or more I/O devices. Computer system 1300 may include one or more of these I/O devices, where appropriate. One or more of these I/O devices may enable communication between a person and computer system 1300. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 1308 for them. Where appropriate, I/O interface 1308 may include one or more device or software drivers enabling processor 1302 to drive one or more of these I/O devices. I/O interface 1308 may include one or more I/O interfaces 1308, where appropriate. Although this disclosure describes and illustrates a particular I/O interface, this disclosure contemplates any suitable I/O interface.

In particular embodiments, communication interface 1310 includes hardware, software, or both providing one or more interfaces for communication (such as, for example, packet-based communication) between computer system 1300 and one or more other computer systems 1300 or one or more networks. As an example and not by way of limitation, communication interface 1310 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 1310 for it. As an example and not by way of limitation, computer system 1300 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 1300 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 1300 may include any suitable communication interface 1310 for any of these networks, where appropriate. Communication interface 1310 may include one or more communication interfaces 1310, where appropriate. Although this disclosure describes and illustrates a particular communication interface, this disclosure contemplates any suitable communication interface.

In particular embodiments, bus 1312 includes hardware, software, or both coupling components of computer system 1300 to each other. As an example and not by way of limitation, bus 1312 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 1312 may include one or more buses 1312, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

1. A method, comprising:
receiving, by a computing device, an input video stream;
providing, to a convolutional neural network (CNN) implemented on the computing device, a first plurality of consecutive image frames of the input video stream including:
a first target pair of two consecutive image frames;
at least one image frame immediately preceding the first target pair; and
at least one image frame immediately following the first target pair;
generating, by the CNN, a first plurality of interpolated image frames by performing three-dimensional (3D) space-time convolution on the first plurality of consecutive image frames, wherein dimensions in the 3D space-time convolution comprise an image width dimension, an image height dimension, and a temporal depth dimension representing a number of frames in the first plurality of consecutive image frames; and
outputting, by the computing device, an output video stream in which the first plurality of interpolated image frames is inserted between the two consecutive image frames of the first target pair.

2. The method of claim 1, wherein:
the method further comprises:
providing, to the CNN, a second plurality of consecutive image frames of the input video stream including:
a second target pair of two consecutive image frames;
at least one image frame immediately preceding the second target pair; and
at least one image frame immediately following the second target pair; and
generating, by the CNN, a second plurality of interpolated image frames by performing 3D space-time convolution on the second plurality of consecutive image frames; and
inserting the second plurality of interpolated image frames between the two consecutive image frames of the second target pair in the output video stream.

3. The method of claim 1, wherein the first plurality of consecutive image frames comprises two or more consecutive image frames immediately preceding the first target pair and two or more consecutive image frames immediately following the first target pair.

4. The method of claim 1, wherein generating the first plurality of interpolated image frames is performed by the CNN during a single inference pass.

5. The method of claim 1, wherein:
the method further comprises, prior to receiving the input video stream, training the CNN to predict non-linear movements that occur over two or more consecutive image frames of a video stream; and
generating the first plurality of interpolated image frames comprises predicting, based on the first plurality of consecutive image frames, a non-linear movement to be depicted in the first plurality of interpolated image frames.

6. The method of claim 1, wherein:
the first plurality of consecutive image frames represents a stack of image frames input to the CNN; and
generating the first plurality of interpolated image frames comprises performing a 3D space-time convolution operation in which a three-dimensional filter is passed over the stack of image frames in a width dimension common to each of the image frames in the stack of image frames, a height dimension common to each of the image frames in the stack of image frames, and a depth dimension representing the number of image frames in the stack of image frames.

7. The method of claim 6, wherein:
the number of image frames in the first plurality of interpolated image frames is a predetermined number n; and
a frame rate of the output video stream is greater than a frame rate of the input video frame by a factor of (n+1).

8. The method of claim 7, wherein generating the first plurality of interpolated image frames further comprises generating, by a two-dimensional prediction layer of the CNN based on a 3D output of the 3D space-time convolution, the n two-dimensional interpolated image frames.

9. The method of claim 6, wherein:
the first plurality of consecutive image frames comprises image data in a plurality of channels; and
generating the first plurality of interpolated image frames comprises generating, by respective convolutional layers of the CNN, image data for each of a plurality of channels of the first plurality of interpolated image frames based on image data in one or more of the plurality of channels in the first plurality of consecutive image frames.

10. The method of claim 9, wherein:
the plurality of channels comprises a plurality of color channels; and
each of the respective convolutional layers of the CNN operates on image data in one of the plurality of color channels.

11. The method of claim 1, wherein generating the first plurality of interpolated image frames further comprises detecting, by each of one or more two-dimensional filters, a respective image feature of interest in the first plurality of consecutive image frames.

12. One or more computer-readable non-transitory storage media embodying software that is operable when executed to:
receive, by a computing device, an input video stream;
provide, to a convolutional neural network (CNN) implemented on the computing device, a first plurality of consecutive image frames of the input video stream including:
a first target pair of two consecutive image frames;
at least one image frame immediately preceding the first target pair; and
at least one image frame immediately following the first target pair;
generate, by the CNN, a first plurality of interpolated image frames by performing three-dimensional (3D) space-time convolution on the first plurality of consecutive image frames, wherein dimensions in the 3D space-time convolution comprise an image width dimension, an image height dimension, and a temporal depth dimension representing a number of frames in the first plurality of consecutive image frames; and
output, by the computing device, an output video stream in which the first plurality of interpolated image frames is inserted between the two consecutive image frames of the first target pair.

13. The media of claim 12, wherein:
prior to receiving the input video stream, the CNN was trained to predict non-linear movements that occur over two or more consecutive image frames of a video stream; and
generating the first plurality of interpolated image frames comprises predicting, based on the first plurality of consecutive image frames, a non-linear movement to be depicted in the first plurality of interpolated image frames.

14. The media of claim 12, wherein:
the first plurality of consecutive image frames represents a stack of image frames input to the CNN; and
generating the first plurality of interpolated image frames comprises performing a 3D space-time convolution operation in which a three-dimensional filter is passed over the stack of image frames in a width dimension common to each of the image frames in the stack of image frames, a height dimension common to each of the image frames in the stack of image frames, and a depth dimension representing the number of image frames in the stack of image frames.

15. The media of claim 14, wherein:
the number of image frames in the first plurality of interpolated image frames is a predetermined number n;
a frame rate of the output video stream is greater than a frame rate of the input video frame by a factor of (n+1); and
generating the first plurality of interpolated image frames further comprises generating, by a two-dimensional prediction layer of the CNN based on a 3D output of the 3D space-time convolution, the n two-dimensional interpolated image frames.

16. The media of claim 14, wherein:
the first plurality of consecutive image frames comprises image data in a plurality of channels; and
generating the first plurality of interpolated image frames comprises generating, by respective convolutional layers of the CNN, image data for each of a plurality of channels of the first plurality of interpolated image frames based on image data in one or more of the plurality of channels in the first plurality of consecutive image frames.

17. A computing device comprising:
one or more processors; and
one or more computer-readable non-transitory storage media coupled to one or more of the processors and comprising program instructions operable when executed by one or more of the processors to cause the system to:
receive, by the computing device, an input video stream;
provide, to a convolutional neural network (CNN) implemented on the computing device, a first plurality of consecutive image frames of the input video stream including:
a first target pair of two consecutive image frames;
at least one image frame immediately preceding the first target pair; and
at least one image frame immediately following the first target pair;
generate, by the CNN, a first plurality of interpolated image frames by performing three-dimensional (3D) space-time convolution on the first plurality of consecutive image frames, wherein dimensions in the 3D space-time convolution comprise an image width dimension, an image height dimension, and a temporal depth dimension representing a number of frames in the first plurality of consecutive image frames; and
output, by the computing device, an output video stream in which the first plurality of interpolated image frames is inserted between the two consecutive image frames of the first target pair.

18. The computing device of claim 17, wherein:
prior to receiving the input video stream, the CNN was trained to predict non-linear movements that occur over two or more consecutive image frames of a video stream; and
generating the first plurality of interpolated image frames comprises predicting, based on the first plurality of consecutive image frames, a non-linear movement to be depicted in the first plurality of interpolated image frames.

19. The computing device of claim 17, wherein:
the first plurality of consecutive image frames represents a stack of image frames input to the CNN;
the number of image frames in the first plurality of interpolated image frames is a predetermined number n;
a frame rate of the output video stream is greater than a frame rate of the input video frame by a factor of (n+1); and
generating the first plurality of interpolated image frames comprises:
performing a 3D space-time convolution operation in which a three-dimensional filter is passed over the stack of image frames in a width dimension common to each of the image frames in the stack of image frames, a height dimension common to each of the image frames in the stack of image frames, and a depth dimension representing the number of image frames in the stack of image frames; and
generating, by a two-dimensional prediction layer of the CNN based on a 3D output of the 3D space-time convolution, the n two-dimensional interpolated image frames.

20. The computing device of claim 19, wherein:
the first plurality of consecutive image frames comprises image data in a plurality of channels; and
generating the first plurality of interpolated image frames comprises generating, by respective convolutional layers of the CNN, image data for each of a plurality of channels of the first plurality of interpolated image frames based on image data in one or more of the plurality of channels in the first plurality of consecutive image frames.
